(19) United States
(12) Patent Application Publication
(10) Pub. No.: US 2020/0285713 A1
(43) Pub. Date: Sep. 10, 2020

(54) ADAPTABLE STRUCTURAL ANALYSIS SYSTEMS AND METHODS

(71) Applicant: THE BOEING COMPANY, CHICAGO, IL (US)

(72) Inventors: Gregory H. DeVore, Seattle, WA (US); Michael R. Rush, Arlington, WA (US)

(73) Assignee: THE BOEING COMPANY, CHICAGO, IL (US)

(21) Appl. No.: 16/292,664

(22) Filed: Mar. 5, 2019

(51) Int. Cl. G06F 17/50; B64C 7/00; G06N 7/00; G06F 17/16

(52) U.S. Cl. CPC G06F 17/5095; G06F 17/16; G06N 7/00; B64C 7/00

(57) ABSTRACT

A structural analysis system and method for efficiently analyzing a finite element model (for example, loads and model data) that represents a structure include identifying, by a model analysis control unit, elements of the finite element model, automatically grouping, by the model analysis control unit, the elements into sets, and associating, by the model analysis control unit, the sets with components of the structure.

### FIELD OF THE DISCLOSURE

Embodiments of the present disclosure generally relate to structural analysis systems and methods, and more particularly, to systems and methods for analyzing finite element models representative of structures.

### BACKGROUND OF THE DISCLOSURE

During development of a vehicle, various analyses are performed with respect to numerous components of the vehicle. Structural loads analyses are performed with respect to the components of the vehicle. For example, during the development of an aircraft, structural loads are analyzed with respect to sections of wings.

Data regarding the structure may be stored as a finite element model. Typically, structures analysis engineers access the finite element model of the structure, and manually extract loads and other information. In order to do so, the structures analysis engineers know where the various components of the structure are, and determine finite elements associated with the known components. However, such a process is tedious and time-consuming. In particular, in a finite element model, there are nodes and elements, which are represented by numerical identifiers, which are not associated with the components of the structure. That is, a finite element model of a structure does not associate the unique numerical identifiers with the structure. Instead, the individual engineers need to review the various numerical identifiers and associate them with the various components of the structure. In short, the engineer(s) selects various numerical identifiers of the finite element model and sort them in relation to the various components of the structure. As such, in order to associate the numerical identifiers of the finite element model with components, the knowledge and expertise of individual specialists (such as structures analysis engineers) is typically required.

As an example, a spar of a wing of an aircraft includes various components, such as a lateral portion, a top, and a bottom. In a finite element model, the various components are shown as a plate elements and bars, for example. Each of the plate elements and bars is represented by a unique numerical identifier. During development of the wing, loads analyses are determined for each of the elements. However, correlating the individual elements with the components of the wings is not readily apparent, and typically requires a specialist to perform. Further, different specialists may associate different elements together. Moreover, a wing design may be changed numerous times during development. With each new iteration, the process of specialists associating the various elements with the components and performing loads analyses is conducted again, which is labor and time intensive and may be prone to human error.

### SUMMARY OF THE DISCLOSURE

A need exists for a system and a method that efficiently analyze a finite element model of a structure. Further, a need exists for a system and a method that automatically associate elements of a finite element model with components of a structure. Additionally, a need exists for a system and a method that facilitate efficient loads analysis and element property review of components of a structure.

With those needs in mind, certain embodiments of the present disclosure provide a structural analysis method for efficiently analyzing a finite element model that represents a structure. The structural analysis method includes identifying, by a model analysis control unit, elements of the finite element model, automatically grouping, by the model analysis control unit, the elements into sets, and associating, by the model analysis control unit, the sets with components of the structure. The structural analysis method may also include storing the finite element model in a finite element model database that is coupled to the model analysis control unit.

In at least one embodiment, the identifying includes selecting a first element, and identifying second elements that neighbor the first element. As a further example, the identifying also includes identifying third elements that neighbor each of the second elements. The third elements are not previously identified as the first element or the second elements. As a continued example, the identifying also includes identifying additional elements until all elements of the finite element model are identified.

In at least one embodiment, the automatically grouping step includes determining normal vectors for each of the elements that are identified, and grouping the sets based on a similarity between normal vectors that are common to the elements.

As one example, the structure is a wing of an aircraft, and the components include at least one skin, at least one spar, at least one stinger, and at least one rib.

The structural analysis method may also include storing component data in a memory that is coupled to the model analysis control unit.

In at least one embodiment, the structure is a wing, the components include an upper skin, a lower skin, a fore spar, an aft spar, and ribs, and the associating includes determining that the upper skin includes first normal vectors having a dominant vertical component pointing upward, the lower skin includes second normal vectors having a dominant vertical component pointing downward, the fore spar includes third normal vectors pointing forward, the aft spar includes fourth normal vectors pointing rearward, and the ribs include fifth normal vectors pointing in a lateral direction.

In at least one embodiment, the structural analysis method further includes determining, by the model analysis control unit, sub-groups of the components. In at least one embodiment, the structural analysis method further includes organizing the components, by the model analysis control unit, by centroids of elements within the components. As one example, the structural analysis method includes organizing the components, by the model analysis control unit, into bays, such as between individual ribs. The organizing includes directionally sorting the elements of the bays. In at least one embodiment, the organizing includes projecting centroids of the elements along a direction of the least variance between the centroids, determining strips within the bays based on the projecting, and determining a number of spanwise elements based on the determining the strips step.

In at least one embodiment, the structural analysis method further includes analyzing, with the model analysis control unit, a plurality of finite element models, learning, with the model analysis control unit, component associations based on the analyzing, and suggesting, with the model analysis control unit, whether various features within a new finite element model represent one or more particular components or one or more new and different features not previously analyzed.

Certain embodiments of the present disclosure provide a structural analysis system for efficiently analyzing a finite element model that represents a structure. The structural analysis system includes a model analysis control unit that identifies elements of the finite element model, automatically groups the elements into sets, and associates the sets with components of the structure.

In at least one embodiment, the model analysis control unit identifies the elements of the finite element model by selecting a first element, identifying second elements that neighbor the first element, identifying third elements that neighbor each of the second elements (wherein the third elements are not previously identified as the first element or the second elements), and identifying additional elements until all elements of the finite element model are identified.

In at least one embodiment, the model analysis control unit automatically groups the elements into sets by determining normal vectors for each of the elements that are identified, and grouping the sets based on a similarity between normal vectors that are common to the elements.

### BRIEF DESCRIPTION OF THE DRAWINGS

FIG. 1 illustrates a schematic block diagram of a structural analysis system, according to an embodiment of the present disclosure.

FIG. 2 illustrates a perspective view of a finite element model of a structure.

FIG. 3 illustrates a flow chart of a method of identifying each element of a finite element model, according to an embodiment of the present disclosure.

FIG. 4 illustrates a perspective view of a portion of the finite element model.

FIG. 5 illustrates a flow chart of a method of organizing the finite element model into logical sets, according to an embodiment of the present disclosure.

FIG. 6 illustrates a perspective view of the finite element model separated into components.

FIG. 7 illustrates a perspective view of the finite element model separated into components.

FIG. 8 illustrates a flow chart of a method of determining bays of the finite element model, according to an embodiment of the present disclosure.

FIG. 9 illustrates a component in relation to a reference plane, according to an embodiment of the present disclosure.

FIG. 10 illustrates a perspective view of a bay, according to an embodiment of the present disclosure.

FIG. 11 illustrates projected centroids of a bay, according to an embodiment of the present disclosure.

FIG. 12 illustrates a two-dimensional representation of projected centroids of a component, according to an embodiment of the present disclosure.

FIG. 13 illustrates a finite element model of a structure shown on a display, according to an embodiment of the present disclosure.

### DETAILED DESCRIPTION OF THE DISCLOSURE

The foregoing summary, as well as the following detailed description of certain embodiments, will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition may include additional elements not having that condition.

Certain embodiments of the present disclosure provide structural analysis systems and methods that automate loads model data extraction (loads, stresses and strains) for structural models (such as those of vehicles). The structural analysis systems and methods facilitate robustness, repeatability, and commonality with respect to structural designs, which may change over time.

Embodiments of the present disclosure are configured to facilitate efficient analysis of structural loads during development of a structure, such as a wing of an aircraft. The embodiments include structural analysis systems and methods that automatically extract data, such as loads and properties.

In at least one embodiment, loads data includes element and nodal based results. Model data includes location, size, and properties. Properties may be element or sectional.

In at least one embodiment, the structural analysis system and method do not rely on a specific numbering convention used in a finite element model (which includes one or both of loads and model data). Instead, the structural analysis system and method analyzes geometric information to detect the presence or absence of key structural components and groups them accordingly. Embodiments of the present disclosure provide adaptable, flexible, and efficient systems and methods that efficiently analyze a finite element model of virtually any structure (such as a wing side of body and carry-through box of an aircraft).

In at least one embodiment, the structural analysis system includes a model analysis control unit that automatically detects the presence or absence of components within the finite element model (for example, skins, stringers, spars, ribs, spanwise beams, longitudinal beams, trap panel, keel beam, and/or the like). The model analysis control unit does not rely on the specific numbering convention used in the finite element model. Instead, the model analysis control unit analyzes geometric information to detect and group individual structural components. The flexibility of embodiments of the present disclosure allows virtually any structure (such as wing side of body and carry-through box of an aircraft) to be studied without any changes to the model analysis control unit, thereby greatly simplifying and accelerating iteration and exploration activities. Embodiments of the present disclosure provide automated, robust, repeatable, agile, and efficient structural analysis systems and methods.

In at least one embodiment, vision for the model analysis control unit to export model loads data is found and grouped to at least one consumable comma separated variable file. In at least one embodiment, the model analysis control unit may sort through load results to envelope, create plots for load case sorting, or provide user selected or case combinations.

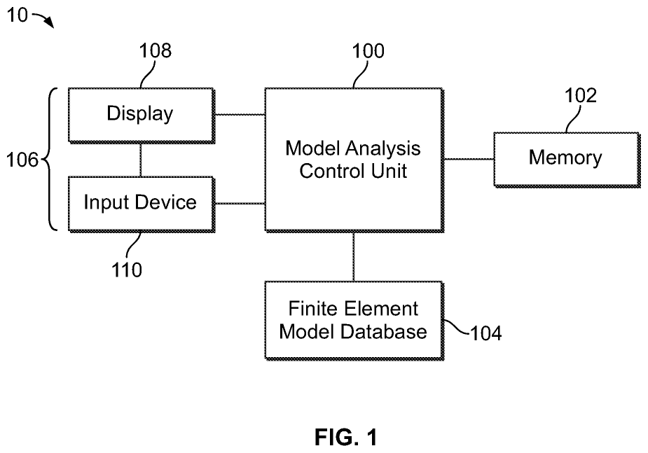

FIG. 1 illustrates a schematic block diagram of a structural analysis system 10, according to an embodiment of the present disclosure. The structural analysis system 10 includes a model analysis control unit 100 coupled to a memory 102, such as through one or more wired or wireless connections. In at least one embodiment, the model analysis control unit 100 includes the memory 102. The model analysis control unit 100 is also coupled to a finite element model database 104, such as through one or more wired or wireless connections. A user interface 106 includes a display 108 and an input device 110, which are coupled to the model analysis control unit 100, such as through one or more wired or wireless connections. The display 108 may be a monitor or screen, for example. The input device 110 may be a keyboard, mouse, and/or the like. In at least one embodiment, the user interface 106 integrated the display 108 and the input device 110 into a touchscreen interface.

The finite element model database 104 stores a finite element model of a structure. The structure may include various components.

As described herein, the structural analysis system 10 is configured to efficiently analyze a finite element model of a structure. The structural analysis system 10 includes the model analysis control unit 100 that identifies the elements of the finite element model, automatically groups the elements into sets or groups, and associate the logical sets with components of the structure. Each logical set is associated with a respective component. A structural analysis method that efficiently analyzes a finite element model of a structure includes identifying elements of the finite element model, automatically grouping the elements into set or groups, and associating the sets with components of the structure.

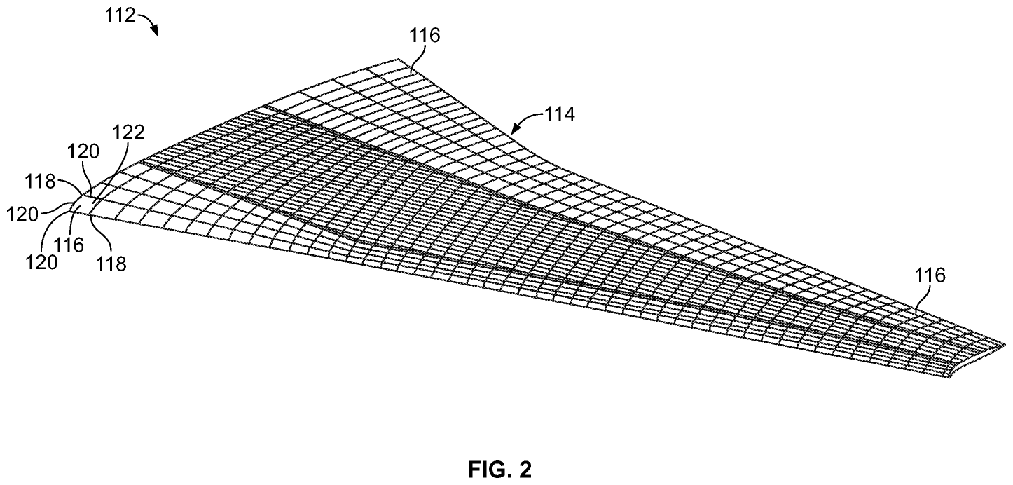

FIG. 2 illustrates a perspective view of a finite element model 112 of a structure 114. As shown, the structure 114 is a wing of an aircraft. Optionally, the structure 114 may be a fuselage, an empennage, or various other portions of the aircraft. Also, optionally, the structure 114 may be of a portion of another vehicle (such as an automobile), a fixed structure (such as building), or the like. It is to be understood that the structure 114 is not limited to an aircraft. FIG. 2 merely provides an example of a structure 114.

The finite element model 112 of the structure 114 includes a plurality of elements 116. Each element 116 is formed by a plurality of nodes 118 and bars 120 that form a shape 122, such as a quadrilateral shape. Optionally, the shape 122 may be various other shapes, such as triangular. The nodes 118 represent zero-dimensional finite elements, such as points. The bars 120 represent one-dimensional elements, such as lines. The shapes 122 represent two-dimensional elements, such as shells.

Referring to FIGS. 1 and 2, in operation, the model analysis control unit 100 analyzes the finite element model 112 and organizes the finite element model 112 into logical sets. The model analysis control unit 100 begins the analysis of the finite element model 112 by selecting any of the elements 116 of the finite element model 112.

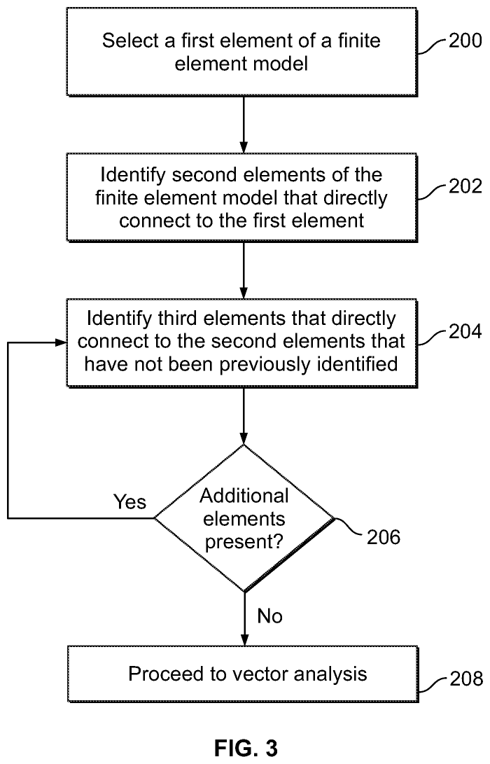

FIG. 3 illustrates a flow chart of method of identifying each element of the finite element model 112, according to an embodiment of the present disclosure. Referring to FIGS. 1-3, the model analysis control unit 100 analyzes the finite element model 112, which is stored in the finite element model database 104. At 200, the model analysis control unit 100 selects a first element 116a of the finite element model 112. The model analysis control unit 100 may select any element 116 of the finite element model 112 as the first element 116a.

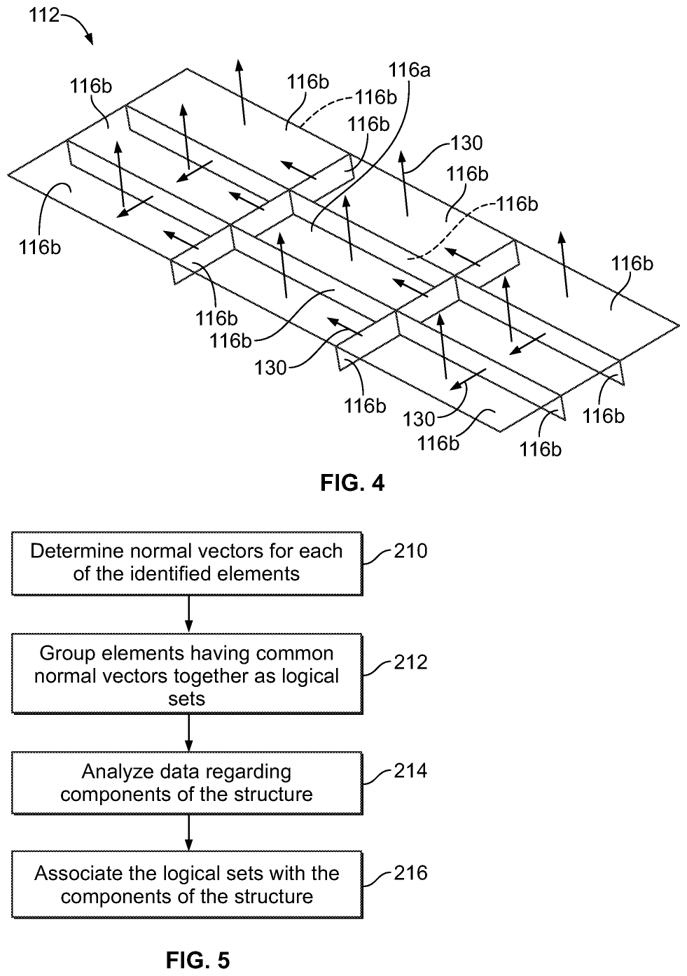

FIG. 4 illustrates a perspective view of a portion of the finite element model 112. Referring to FIGS. 1-4, the model analysis control unit 100 selects the first element 116a.

After the first element 116a is selected, the model analysis control unit 100 then identifies second elements 116b of the finite element model 112 that directly connect to (that is, neighbor) the first element 116a. The process then repeats for each of the second elements 116b. In particular, at 204, the model analysis control unit 100 identifies third elements that directly connect to the second elements 116b that have not been previously identified in step 202. The model analysis control unit 100 then determines if there are additional elements present in the finite element model 112. If so, the process returns to 204, and additional elements (for example, fourth elements) that directly connect to the third elements are identified. The process continues to repeat until all elements of the finite element model 112 are identified. At 206, if no additional elements are present, the method proceeds to vector analysis at 208.

FIG. 5 illustrates a flow chart of a method of organizing the finite element model 112 into logical sets, according to an embodiment of the present disclosure. Referring to FIGS. 1-5, after all of the elements 116 of the finite element model 112 have been identified by the model analysis control unit 100, at 210, the model analysis control unit 100 determines normal vectors for each of the identified elements 116. Referring to FIG. 4, in particular, the normal vectors 130 are perpendicular to a face of each element 116. The memory 102 may store instructions for the directions of each normal vector 130 in relation to each face, based on predetermined data.

After the normal vectors 130 for each of the identified elements 116 are determined, the model analysis control unit 100 at 212 groups the elements 116 having common (that is, oriented in the same direction) normal vectors 130 together. For example, the common normal vectors 130 are parallel to one another and oriented in the same direction. In at least one embodiment, the model analysis control unit 100 determines that normal vectors 130 are common if they are within a particular threshold of commonality. For example, the threshold of commonality between two vectors may be an inner product greater than 0.9 (in which a range is between 0, indicating perfectly orthogonal vectors, and 1, indicating perfectly parallel vectors). In this manner, the threshold of commonality accounts for a variable shape of the structure 114.

Based on the common normal vectors 130, the model analysis control unit 100 organizes the elements 116 into logical sets. In at least one embodiment, the memory 102 includes data regarding the different components of the structure 114 represented by the finite element model 112. At 214, the model analysis control unit 100 analyzes data regarding components of the structure 114. For example, the data regarding the components of the structure 114 indicates that elements 116 having a first common vector are part of a first component, such as an upper skin, and that elements having a second common vector that differs from the first common vector are part of a second component, such as a stringer. At 216, the model analysis control unit 100 associates the logical sets with components of the structure 114, as stored in the memory 102, for example.

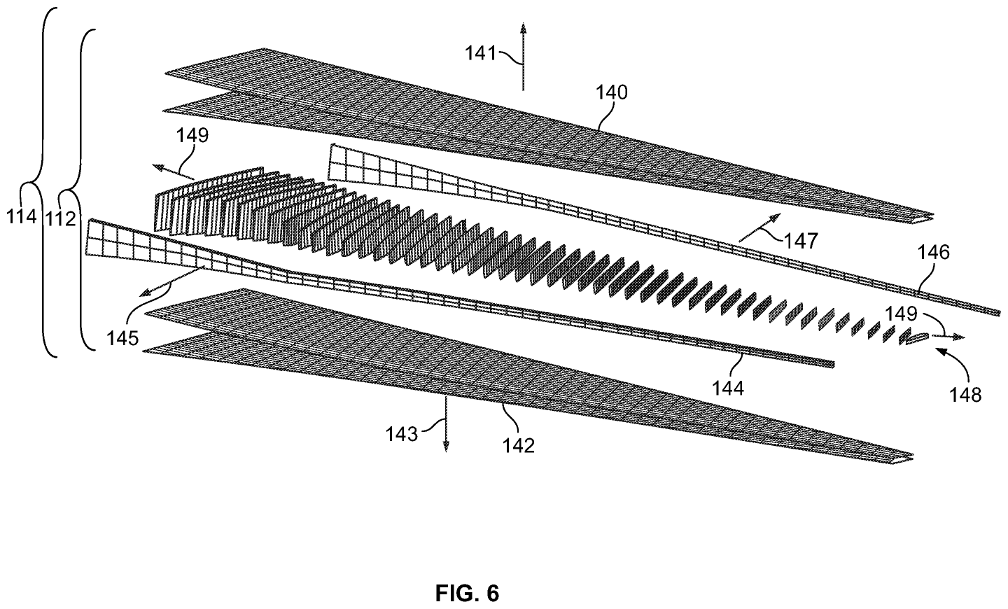

FIG. 6 illustrates a perspective view of the finite element model 112 separated into components 140, 142, 144, 146, and 148. As described above, the model analysis control unit 100 determines the different logical sets, and therefore the components 140-148 by grouping the logical sets together according to common vectors, and then referencing the data stored in the memory 102 to associate the logical sets with the components 140-148 of the structure 114. As an example, the component 140 may include an upper skin and a lower skin of a wing, the component 142 may include upper and lower stringers of the wing, the component 144 may be a fore spar of the wing, the component 146 may be an aft spar of the wing, and the component 148 may include the ribs of the wing.

In at least one embodiment, the model analysis control unit 100 calculates an average normal vector and total surface area for each logical set, and therefore component. The model analysis control unit 100 may use the average normal vector and total surface area to classify each logical set as a component, for example.

In at least one embodiment, the model analysis control unit 100 identifies individual components of a wing. For example, based on instructions stored in the memory 102, the model analysis control unit 100 determines that: the upper skin is the largest group whose average normal vectors 141 have a dominant vertical component pointing upward, the lower skin is the largest group whose average normal vectors 143 have a dominant vertical component pointing downward, the fore spar has average normal vectors 145 pointing forward, the aft spar has average normal vectors 147 pointing rearward, and the ribs have average normal vectors 149 pointing in a lateral direction. In at least one embodiment, the model analysis control unit 100 determines outermost spars as the fore spar and the rear spar, outermost ribs as interior and exterior ribs, spars between the fore spar and the rear spar as spanwise beams, and ribs between the interior and exterior ribs as intermediate ribs.

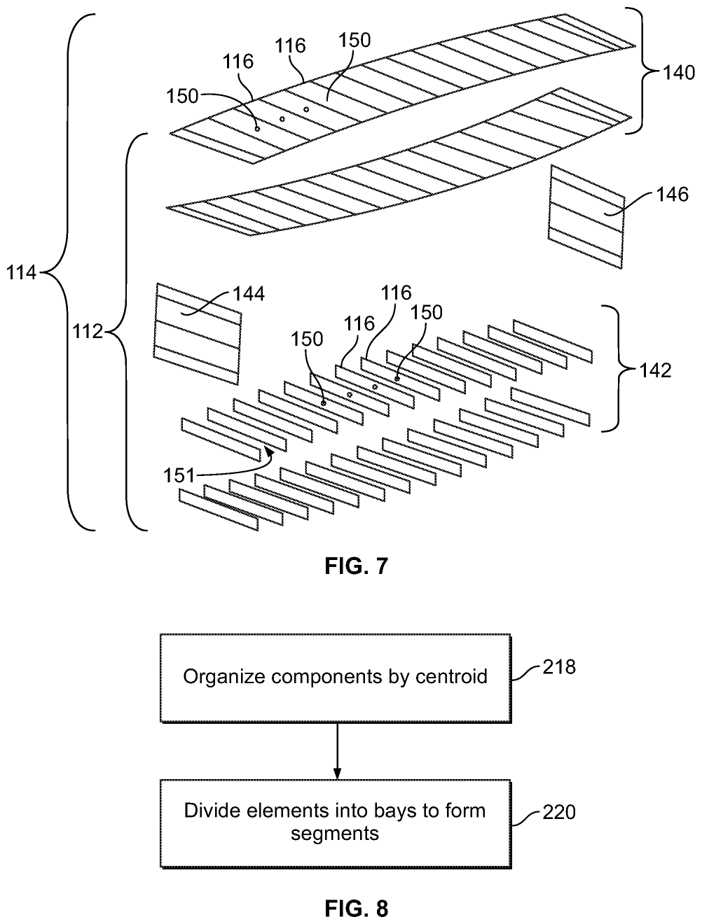

FIG. 7 illustrates a perspective view of the finite element model 112 separated into components. In at least one embodiment, after the model analysis control unit 100 groups the elements 116 into the logical sets and therefore the components, the model analysis control unit 100 determines sub-groups of the components. Each of the elements 116 includes a centroid 150. The components 148 of FIG. 6 are not shown in FIG. 7.

FIG. 8 illustrates a flow chart of a method of determining bays of the finite element model 112, according to an embodiment of the present disclosure. At 218, the model analysis control unit 100 organizes the components by the centroids 150 of the elements 116 within the components. The model analysis control unit 100 may then divide the elements 116 into bays 151 to form segments at 220. The bays 151 are formed by adjacent ribs 148 (that is, two ribs closest to one another), and all connecting structure and space between. For example, a bay 151 may represent the space between two ribs, including portions of skins above and below.

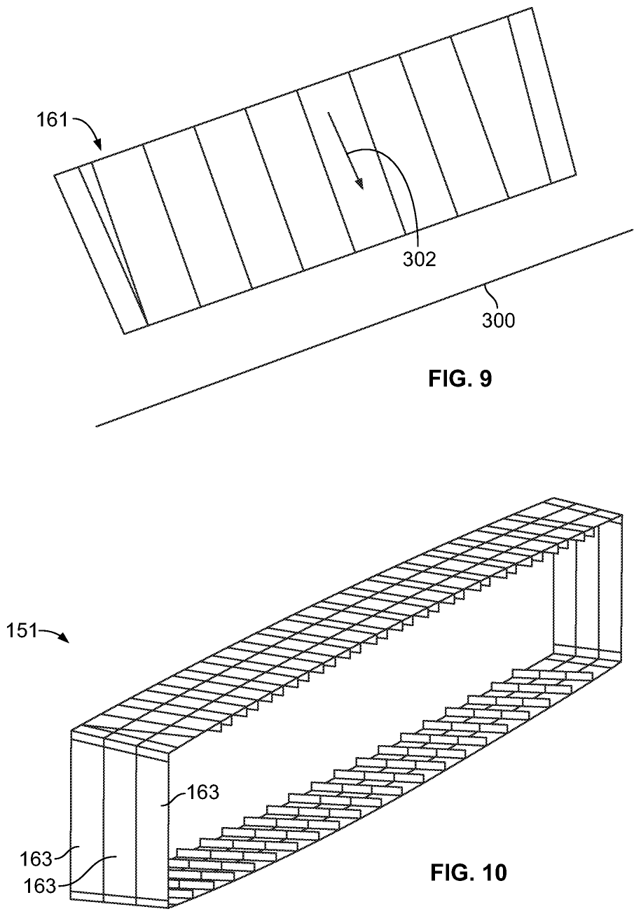

FIG. 9 illustrates a component 161 (such as any of those described herein) in relation to a reference plane 300, according to an embodiment of the present disclosure. In at least one embodiment, the model analysis control unit 100 determined an optimal projection direction 302 for sorting elements. In at least one embodiment, the model analysis control unit 100 determines the singular value decomposition of the centroids of the elements to provide a desired projection direction. By determining the projection direction, the components may be sorted along projected fore-aft coordinates.

In at least one embodiment, within a bay 151, the model analysis control unit 100 directionally sorts the elements, such as from back to front. In at least one embodiment, the model analysis control unit 100 determines that the bays 151 define segments, or may be further organized into segments. Because certain wings, for example, may be angled, they may not be sorted in a global sense, due to directional issues. As such, the model analysis control unit 100 may sort and projects centroid of the elements onto a line and sort in an oriented direction. In at least one embodiment, the model analysis control unit 100 determines the reference plane 300 by analyzing a cloud of points represented by the centroids of the elements. In particular, the model analysis control unit 100 may determine a direction of natural variance, and determine the reference plane 300 thereby.

FIG. 10 illustrates a perspective view of a bay 151, according to an embodiment of the present disclosure. As noted, the model analysis control unit 100 may determine bays 151 of the structure 114 as represented by the finite element model 112. Certain models may contain spanwise elements in a single bay or region. Accordingly, the model analysis control unit 100 may segment the bay 151 in two dimensions. For example, the bay 151 shown in FIG. 10, the bay 151 includes three spanwise strips 163.

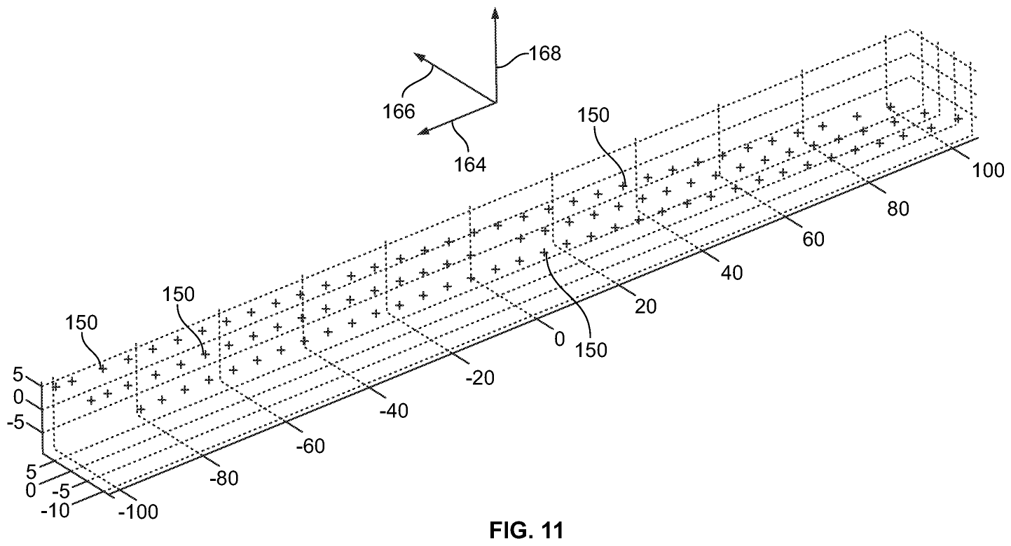

FIG. 11 illustrates projected centroids 150 of a bay, according to an embodiment of the present disclosure. For regions with multiple spanwise elements, the model analysis control unit 100 may calculate the eigenvectors of the centroid covariance matrix. The model analysis control unit 100 determines a direction 164 of the most variance between the centroids 150, a direction 166 of intermediate variance between the centroids 150, and a direction 168 of the least variance between the centroids 150.

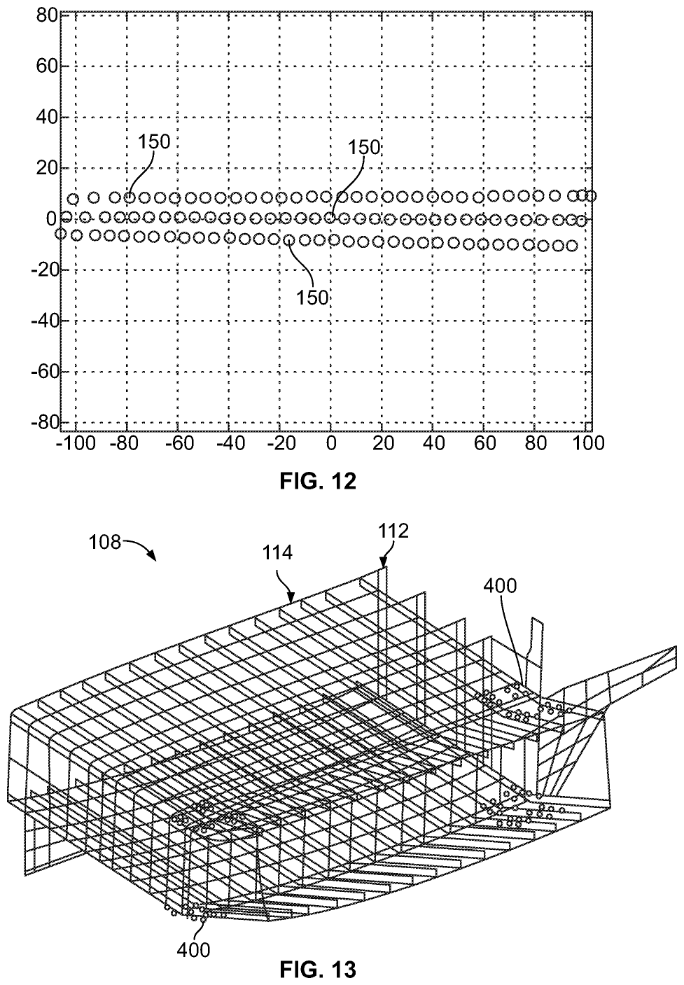

FIG. 12 illustrates a two-dimensional representation of projected centroids 150 of a component, according to an embodiment of the present disclosure. The model analysis control unit 100 may project the centroids 150 along the direction 168 of the least variance between the centroids 150 in order to retain the greatest amount of information about the centroids. By projecting the centroids 150 as shown in FIG. 12, the model analysis control unit 100 is able to sort the elements of the component properly and determine the number of strips within the bay 151. In this manner, the model analysis control unit 100 may determine a number of spanwise elements between outer elements of a component.

In particular, in at least one embodiment, the model analysis control unit 100 uses an iterative scheme to calculate the number of spanwise elements. For example, the model analysis control unit 100 generates histograms of centroid data with an increasing number of bins 151. The model analysis control unit 100 may then determine the number of groups, such as by determining a number of adjacent non-empty bins. Next, the model analysis control unit 100 stops iterating when each group contains an equal number (or roughly an equal number) of centroids. The number of resulting groups then corresponds to the number of spanwise elements.

Optionally, the structural analysis method may not include determining bays and segments, as described with respect to FIGS. 8-12.

After the elements have been identified, associated with components and/or grouped, a loads analysis may be conducted for the components and/or elements within the components.

In at least one embodiment, a plurality of finite element models may be stored in the finite element model database 104. The model analysis control unit 100 may analyze each of the stored finite element models and learn the component association with the logical sets based on analysis of the finite element models, as described therein. That is, with repeated analysis of each finite element model, the model analysis control unit 100 tracks results from each analysis and is able to suggest whether various features within a new finite analysis model represent one or more particular components, or one or more new and different features not previously analyzed.

In at least one embodiment, various elements may be stored in memory 102. The elements may be coincident with certain elements of a finite element model. Based on the stored coincident element (such as a doubler for a skin), the model analysis control unit 100 is able to differentiate between the elements and the coincident elements. Thus, in order to differentiate between additional coincident features, data regarding the coincident features may be stored in the memory 102.

The model analysis control unit 100 automatically determines the components of the finite element model, as described above. As such, repeatable, robust, and accurate loads determinations may be made with respect to the various components and elements thereof, in contrast to prior manual methods in which different individuals may associate different elements with different components, and therefore reach different loads determinations.

FIG. 13 illustrates a finite element model 112 of a structure 114 shown on the display 108, according to an embodiment of the present disclosure. Referring to FIGS. 1 and 13, fastener points for the structure 114 may be stored in the memory 102, and overlaid on the finite element model 112 as fastener indicia 400. The model analysis control unit 100 may project the fastener indicia 400 (representative of the fastener locations, such as rivets on a wing) onto the finite element model 112, in wire frame form. The model analysis control unit may use this projection to redistribute loads information.

Loads are information that each structural analysis uses to calculate a margin of safety, such as for a rivet, each of which may be represented by a fastener indication 400. During a development cycle of an aircraft, for example, plans and designs may change rapidly. Each change may affect another feature of the aircraft. A loads model is typically re-run with each design change. As such, the structural analysis system 10 and method described herein is highly efficient in that the model analysis control unit 100 automatically groups elements together, which allows for a faster, more efficient, less costly, and highly accurate loads analysis of the structure 114.

Referring to FIGS. 1-12, the model analysis control unit 100 identifies the elements 116 of the finite element model 112, arranges the elements 116 into groups, and associates the groups with components of a structure. In at least one embodiment, the finite element model 112 sorts the elements within each group, such as based on an optimal projection direction.

In at least one embodiment, the model analysis control unit 100 forms logical sets of elements and associates the logical sets with components (for example, component groups). The model analysis control unit 100 forms the logical sets based on common vectors. The model analysis control unit 100 uses an average group normal vector, group spatial location, and groups surface area to differentiate among component groups. In at least one embodiment, the model analysis control unit 100 arranges the components into sub-groups, such as by splitting large components along a major axis (for example, via bays 151). The model analysis control unit 100 may combine similar sub-groups together, such as spanwise beams, which may be determined via projecting the centroids 150, as described with respect to FIGS. 11-12. The model analysis control unit 100 may also sort and organize the components and/or sub-groups along axes (for example, a fore-aft axis for skins, inboard-outboard axis for spars, and the like).

Thus, embodiments of the present disclosure provides structural analysis systems and methods that are configured to automatically identify elements of a finite element model, group the elements based on logical sets, and associate the logical sets with components of a structure. The systems and methods efficiently analyze a finite element model of a structure, automatically associate elements of the finite element model with the components of the structure, and facilitate efficient loads analysis of the components of the structure.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the model analysis control unit 100 may be or include one or more processors that are configured to control operation thereof, as described herein.

The model analysis control unit 100 is configured to execute a set of instructions that are stored in one or more data storage units or elements (such as one or more memories), in order to process data. For example, the model analysis control unit 100 may include or be coupled to one or more memories. The data storage units may also store data or other information as desired or needed. The data storage units may be in the form of an information source or a physical memory element within a processing machine.

The set of instructions may include various commands that instruct the model analysis control unit 100 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the model analysis control unit 100. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the model analysis control unit 100 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Embodiments of the present disclosure provide systems and methods that allow large amounts of data to be quickly and efficiently analyzed by a computing device. For example, a finite element model may include hundreds, thousands, if not millions of elements. As such, large amounts of data are being tracked and analyzed. The vast amounts of data are efficiently organized and/or analyzed by the model analysis control unit 100, as described herein. The model analysis control unit 100 analyzes the data in a relatively short time in order to quickly and efficiently output and/or component groupings, upon which loads analyses may then be performed. A human being would be incapable of efficiently analyzing such vast amounts of data in such a short time. As such, embodiments of the present disclosure provide increased and efficient functionality with respect to prior computing systems, and vastly superior performance in relation to a human being analyzing the vast amounts of data. In short, embodiments of the present disclosure provide systems and methods that analyze thousands, if not millions, of calculations and computations that a human being is incapable of efficiently, effectively and accurately managing.

As described herein, embodiments of the present disclosure provide systems and methods that efficiently analyze a finite element model of a structure. Further, embodiments of the present disclosure provide systems and methods that automatically associate elements of a finite element model with components of a structure. Additionally, embodiments of the present disclosure provide systems and methods that facilitate efficient loads analysis of components of a structure.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. A structural analysis method for efficiently analyzing a finite element model that represents a structure, the structural analysis method comprising:
identifying, by a model analysis control unit, elements of the finite element model;
automatically grouping, by the model analysis control unit, the elements into sets; and
associating, by the model analysis control unit, the sets with components of the structure.

2. The structural analysis method of claim 1, further comprising storing the finite element model in a finite element model database that is coupled to the model analysis control unit.

3. The structural analysis method of claim 1, wherein the identifying comprises:
selecting a first element; and
identifying second elements that neighbor the first element.

4. The structural analysis method of claim 3, wherein the identifying further comprises identifying third elements that neighbor each of the second elements.

5. The structural analysis method of claim 4, wherein the third elements are not previously identified as the first element or the second elements.

6. The structural analysis method of claim 3, wherein the identifying further comprises identifying additional elements until all elements of the finite element model are identified.

7. The structural analysis method of claim 1, wherein the automatically grouping comprises:
determining normal vectors for each of the elements that are identified; and
grouping the sets based on normal vectors that are common to the elements.

8. The structural analysis method of claim 1, wherein the structure is a wing of an aircraft, and wherein the components comprise at least one skin, at least one spar, at least one stinger, and at least one rib.

9. The structural analysis method of claim 1, further comprising storing component data in a memory that is coupled to the model analysis control unit.

10. The structural analysis method of claim 1, wherein the structure is a wing, the components comprise an upper skin, a lower skin, a fore spar, an aft spar, and ribs, and the associating comprises determining that the upper skin includes first normal vectors having a dominant vertical component pointing upward, the lower skin includes second normal vectors having a dominant vertical component pointing downward, the fore spar includes third normal vectors pointing forward, the aft spar includes fourth normal vectors pointing rearward, and the ribs include fifth normal vectors pointing in a lateral direction.

11. The structural analysis method of claim 1, further comprising determining, by the model analysis control unit, sub-groups of the components.

12. The structural analysis method of claim 1, further comprising organizing the components, by the model analysis control unit, by centroids of elements within the components.

13. The structural analysis method of claim 1, further comprising organizing the components, by the model analysis control unit, into bays.

14. The structural analysis method of claim 13, wherein the organizing comprises directionally sorting the elements of the bays.

15. The structural analysis method of claim 13, wherein the organizing comprises:
projecting centroids of the elements along a direction of least variance between the centroids;
determining strips within the bays based on the projecting; and
determining a number of spanwise elements based on the determining the strips.

16. The structural analysis method of claim 1, further comprising:
analyzing, with the model analysis control unit, a plurality of finite element models;
learning, with the model analysis control unit, component associations based on the analyzing; and
suggesting, with the model analysis control unit, whether one or more features within a new finite element model represent one or more particular components or one or more new and different features not previously analyzed.

17. A structural analysis system for efficiently analyzing a finite element model that represents a structure, the structural analysis system comprising a model analysis control unit that:
identifies elements of the finite element model;
automatically groups the elements into sets; and
associates the sets with components of the structure.

18. The structural analysis system of claim 17, wherein the model analysis control unit identifies the elements of the finite element model by:
selecting a first element;
identifying second elements that neighbor the first element;
identifying third elements that neighbor each of the second elements, wherein the third elements are not previously identified as the first element or the second elements; and
identifying additional elements until all elements of the finite element model are identified.

19. The structural analysis system of claim 17, wherein the model analysis control unit automatically groups the elements into sets by:
determining normal vectors for each of the elements that are identified; and
grouping the sets based on normal vectors that are common to the elements.

20. A structural analysis method for efficiently analyzing a finite element model including one or both of loads and model data that represents a structure, the structural analysis method comprising:
storing the finite element model in a finite element model database that is coupled to a model analysis control unit;
storing component data in a memory that is coupled to the model analysis control unit;
identifying, by a model analysis control unit, elements of the finite element model, wherein the identifying comprises selecting a first element, identifying second elements that neighbor the first element, identifying third elements that neighbor each of the second elements, wherein the third elements are not previously identified as the first element or the second elements, and identifying additional elements until all elements of the finite element model are identified;
automatically grouping, by the model analysis control unit, the elements into sets, wherein the automatically grouping comprises determining normal vectors for each of the elements that are identified, and grouping the sets based on normal vectors that are common to the elements;
associating, by the model analysis control unit, the sets with components of the structure; and
organizing the components, by the model analysis control unit, into bays, wherein the organizing comprises projecting centroids of the elements along a direction of least variance between the centroids, determining strips within the bays based on the projecting, and determining a number of spanwise elements based on the determining the strips.
